(19) United States
(12) Patent Application Publication
(10) Pub. No.: US 2024/0104304 A1
(43) Pub. Date: Mar. 28, 2024

(54) METHODS AND APPARATUSES FOR ESTIMATING WORD SEGMENT FREQUENCY IN DIFFERENTIAL PRIVACY PROTECTION DATA

(71) Applicant: Alipay (Hangzhou) Information Technology Co., Ltd., Hangzhou (CN)

(72) Inventors: Ruofan Wu, Hangzhou (CN); Leilei Shi, Hangzhou (CN); Yonghuan Chen, Hangzhou (CN); Yaowei Zhu, Hangzhou (CN)

(21) Appl. No.: 18/275,995

(22) PCT Filed: Jan. 25, 2022
(86) PCT No.: PCT/CN2022/073677

§ 371 Date: Aug. 4, 2023

(30) Foreign Application Priority Data
Feb. 5, 2021 (CN) 202110161186.9

(51) Int. Cl. G06F 40/284; G06F 40/242

(52) U.S. Cl. CPC G06F 40/284; G06F 40/242

(57) ABSTRACT

This specification provides a method and an apparatus for estimating a word segment frequency in differential privacy protection data, and an electronic device. According to the method, each piece of word segment information that is reported by a terminal device and that is subject to local differential privacy processing is obtained; N groups of word segment information are obtained through division, so each piece of word segment information of the same group corresponds to the same target quantity; each group of estimated data that is corresponding to each group of word segment information and that represents unbiased word segment frequency estimation is determined; and each layer of nodes of a prefix tree used to record a word segment frequency is generated layer by layer based on each group of estimated data.

### TECHNICAL FIELD

One or more embodiments of this specification relate to the technical field of data mining, and in particular, to methods and apparatuses for estimating a word segment frequency in differential privacy protection data.

### BACKGROUND

Text information entered or viewed by a user by using a terminal device (such as a message, a chat record, or a search record) can directly or indirectly reflect a feature and a preference of the user. This text information is of great significance for data mining and analysis. However, the text information involves personal privacy of the user. Therefore, the terminal device can generally perform local differential privacy processing on the text information entered or viewed by the user to obtain differential privacy protection data, and report the differential privacy protection data to a server, so the server estimates a word segment frequency (a quantity of times that a word segment appears in a text) in the differential privacy protection data. Therefore, in a process of estimating the word segment frequency, how to estimate the word segment frequency more efficiently and reasonably when a calculation amount is relatively small becomes particularly important in the data mining field.

### SUMMARY

To alleviate one of the previous technical problems, one or more embodiments of this specification provide methods and apparatuses for estimating a word segment frequency in differential privacy protection data.

According to a first aspect, a method for estimating a word segment frequency in differential privacy protection data is provided, applied to a server, including: obtaining each piece of word segment information that is reported by a terminal device and that is subject to local differential privacy processing, where any piece of word segment information corresponds to one word segment, and includes a target quantity that represents a quantity of word units included in the word segment, and the target quantity is less than or equal to a predetermined value N; obtaining through division N groups of word segment information, so each piece of word segment information of the same group corresponds to the same target quantity; determining each group of estimated data that is corresponding to each group of word segment information and that represents unbiased word segment frequency estimation; and generating, layer by layer based on each group of estimated data, each layer of nodes of a prefix tree used to record a word segment frequency, where generating an nth layer of nodes includes: obtaining each (n−1)-tuple word segment represented by each node at an (n−1)th layer, where an (n−1)-tuple word segment represented by any node at the (n−1)th layer is formed by sequentially arranging word units corresponding to a root node to the node; determining a plurality of candidate n-tuple word segments for the nth layer of nodes based on each (n−1)-tuple word segment; calculating frequency salient distribution information of the candidate n-tuple word segment based on an nth group of estimated data corresponding to a target quantity n; and selecting, based on the frequency salient distribution information, several candidate n-tuple word segments as n-tuple word segments represented by the nth layer of nodes, and recording, by using each node at the nth layer, a frequency of an n-tuple word segment represented by the node, where 1≤n≤N.

Optionally, the root node of the prefix tree is a 0th-layer node, and the 0th-layer node represents an empty character.

Optionally, the determining a plurality of candidate n-tuple word segments for the nth layer of nodes based on each (n−1)-tuple word segment includes: determining, as the plurality of candidate n-tuple word segments, a plurality of n-tuple word segments formed by using each (n−1)-tuple word segment as a prefix and each predetermined word unit in a predetermined dictionary.

Optionally, the calculating frequency salient distribution information of the candidate n-tuple word segment based on an nth group of estimated data corresponding to a target quantity n includes: calculating each frequency of each candidate n-tuple word segment based on the nth group of estimated data; calculating each variance corresponding to each candidate n-tuple word segment based on each frequency; and calculating the frequency salient distribution information of the candidate n-tuple word segment based on each variance.

Optionally, the calculating the frequency salient distribution information of the candidate n-tuple word segment based on each variance includes: calculating each z value corresponding to each candidate n-tuple word segment based on each variance; and calculating each p value corresponding to each candidate n-tuple word segment based on each z value, as the frequency salient distribution information of the candidate n-tuple word segment; where the selecting, based on the frequency salient distribution information, several candidate n-tuple word segments as n-tuple word segments represented by the nth layer of nodes includes: selecting, based on each p value, several candidate n-tuple word segments as the n-tuple word segments represented by the nth layer of nodes.

Optionally, the selecting, based on each p value, several candidate n-tuple word segments as the n-tuple word segments represented by the nth layer of nodes includes: arranging the p values in ascending order; selecting a maximum p value that satisfies a predetermined condition as a target p value, where any p value that satisfies the predetermined condition is less than or equal to a target result corresponding to the p value, and the target result is a result obtained by dividing a product of a sequence number of the p value in the arrangement and a predetermined threshold set for the nth layer by a quantity of candidate n-tuple word segments; and selecting candidate n-tuple word segments corresponding to p values that are less than the target p value as the n-tuple word segments represented by the nth layer of nodes.

Optionally, the method further includes: using each node at the nth layer to record a variance and a p value of an n-tuple word segment represented by the node.

Optionally, the any piece of word segment information further includes a target vector representing the word segment, and the target vector is subject to local differential privacy processing.

Optionally, the target vector representing the word segment is obtained in the following method: selecting one hash function from a plurality of predetermined hash functions as a target hash function; calculating a target hash value of the word segment by using the target hash function; and

determining the target vector based on the target hash value in a method of satisfying differential privacy.

According to a second aspect, an apparatus for estimating a word segment frequency in differential privacy protection data is provided, applied to a server, including: an acquisition module, configured to obtain each piece of word segment information that is reported by a terminal device and that is subject to local differential privacy processing, where any piece of word segment information corresponds to one word segment, and includes a target quantity that represents a quantity of word units included in the word segment, and the target quantity is less than or equal to a predetermined value N; a grouping module, configured to obtain through division N groups of word segment information, so each piece of word segment information of the same group corresponds to the same target quantity; a determining module, configured to determine each group of estimated data that is corresponding to each group of word segment information and that represents unbiased word segment frequency estimation; and a generation module, configured to generate, layer by layer based on each group of estimated data, each layer of nodes of a prefix tree used to record a word segment frequency, where the generation module generates an nth layer of nodes in the following method: obtaining each (n−1)-tuple word segment represented by each node at an (n−1)th layer, where an (n−1)-tuple word segment represented by any node at the (n−1)th layer is formed by sequentially arranging word units corresponding to a root node to the node; determining a plurality of candidate n-tuple word segments for the nth layer of nodes based on each (n−1)-tuple word segment; calculating frequency salient distribution information of the candidate n-tuple word segment based on an nth group of estimated data corresponding to a target quantity n; and selecting, based on the frequency salient distribution information, several candidate n-tuple word segments as n-tuple word segments represented by the nth layer of nodes, and recording, by using each node at the nth layer, a frequency of an n-tuple word segment represented by the node, where 1≤n≤N.

Optionally, the root node of the prefix tree is a 0th-layer node, and the 0th-layer node represents an empty character.

Optionally, the generation module determines the plurality of candidate n-tuple word segments for the nth layer of nodes based on each (n−1)-tuple word segment in the following method: determining, as the plurality of candidate n-tuple word segments, a plurality of n-tuple word segments formed by using each (n−1)-tuple word segment as a prefix and each predetermined word unit in a predetermined dictionary.

Optionally, the generation module calculates the frequency salient distribution information of the candidate n-tuple word segment based on the nth group of estimated data corresponding to the target quantity n in the following method: calculating each frequency of each candidate n-tuple word segment based on the nth group of estimated data; calculating each variance corresponding to each candidate n-tuple word segment based on each frequency; and calculating the frequency salient distribution information of the candidate n-tuple word segment based on each variance.

Optionally, the generation module calculates the frequency salient distribution information of the candidate n-tuple word segment based on each variance in the following method: calculating each z value corresponding to each candidate n-tuple word segment based on each variance; and calculating each p value corresponding to each candidate n-tuple word segment based on each z value, as the frequency salient distribution information of the candidate n-tuple word segment; where the generation module selects, based on the frequency salient distribution information, several candidate n-tuple word segments as the n-tuple word segments represented by the nth layer of nodes in the following method: selecting, based on each p value, several candidate n-tuple word segments as the n-tuple word segments represented by the nth layer of nodes.

Optionally, the generation module selects, based on each p value, several candidate n-tuple word segments as the n-tuple word segments represented by the nth layer of nodes in the following method: arranging the p values in ascending order; selecting a maximum p value that satisfies a predetermined condition as a target p value, where any p value that satisfies the predetermined condition is less than or equal to a target result corresponding to the p value, and the target result is a result obtained by dividing a product of a sequence number of the p value in the arrangement and a predetermined threshold set for the nth layer by a quantity of candidate n-tuple word segments; and selecting candidate n-tuple word segments corresponding to p values that are less than the target p value as the n-tuple word segments represented by the nth layer of nodes.

Optionally, the generation module is further configured to use each node at the nth layer to record a variance and a p value of an n-tuple word segment represented by the node.

Optionally, the any piece of word segment information further includes a target vector representing the word segment, and the target vector is subject to local differential privacy processing.

Optionally, the target vector representing the word segment is obtained in the following method: selecting one hash function from a plurality of predetermined hash functions as a target hash function; calculating a target hash value of the word segment by using the target hash function; and determining the target vector based on the target hash value in a method of satisfying differential privacy.

According to a third aspect, a computer readable storage medium is provided, where the storage medium stores a computer program, and the computer program is executed by a processor to implement the method according to any one of the first aspect.

According to a fourth aspect, an electronic device is provided, including a memory, a processor, and a computer program that is stored in the memory and that is capable of running on the processor, the processor implementing the method according to any one of the first aspect when executing the program.

The technical solutions provided in the embodiments of this specification can include the following beneficial effects: According to the method and the apparatus for estimating a word segment frequency in differential privacy protection data provided in the embodiments of this specification, each piece of word segment information that is reported by a terminal device and that is subject to local differential privacy processing is obtained; N groups of word segment information are obtained through division, so each piece of word segment information of the same group corresponds to the same target quantity; each group of estimated data that is corresponding to each group of word segment information and that represents unbiased word segment frequency estimation is determined; and each layer of nodes of a prefix tree used to record a word segment frequency is generated layer by layer based on each group of estimated data. In the embodiments, in a process of generating an nth layer of nodes of the prefix tree, some candidate n-tuple word segments can be selected, based on frequency salient distribution information of candidate n-tuple word segments, as n-tuple word segments represented by the nth layer of nodes, and it is not necessary to traverse all n-tuple word segments formed by predetermined word units. This greatly reduces a calculation amount and improves calculation efficiency, and the n-tuple word segments represented by the nth layer of nodes and selected based on the frequency salient distribution information of word segments are more reasonable.

It should be understood that the previous general description and the following detailed description are merely an example for explanation, and do not limit this application.

### BRIEF DESCRIPTION OF DRAWINGS

To describe the technical solutions in the embodiments of this application more clearly, the following briefly describes the accompanying drawings needed for describing the embodiments. Clearly, the accompanying drawings in the following description show merely some embodiments of this application, and a person of ordinary skill in the art can still derive other drawings from these accompanying drawings without creative efforts.

FIG. 1 is a schematic diagram illustrating a scenario of estimating a word segment frequency in differential privacy protection data, according to an example embodiment shown in this specification;

FIG. 2 is a flowchart illustrating a method for estimating a word segment frequency in differential privacy protection data, according to an example embodiment of this specification;

FIG. 3 is a flowchart illustrating another method for estimating a word segment frequency in differential privacy protection data, according to an example embodiment of this specification;

FIG. 4 is a block diagram illustrating an apparatus for estimating a word segment frequency in differential privacy protection data, according to an example embodiment of this specification;

FIG. 5 is a schematic diagram illustrating a prefix tree, according to an example embodiment of this specification; and

FIG. 6 is a schematic structural diagram illustrating an electronic device, according to an example embodiment of this specification.

### DESCRIPTION OF EMBODIMENTS

Example embodiments are described in detail here, and examples of the example embodiments are presented in the accompanying drawings. When the following description relates to the accompanying drawings, unless specified otherwise, the same numbers in different accompanying drawings represent the same or similar elements. Embodiments described in the following example embodiments do not represent all embodiments consistent with this specification. On the contrary, the embodiments are merely examples of apparatuses and methods that are described in the appended claims in details and consistent with some aspects of this specification.

The terms used in this specification are merely for illustrating specific embodiments, and are not intended to limit this application. The terms “a” and “the” of singular forms used in this specification and the appended claims are also intended to include plural forms, unless otherwise specified in the context clearly. It should be further understood that the term “and/or” used in this specification indicates and includes any or all possible combinations of one or more associated listed items.

It should be understood that although terms “first”, “second”, “third”, etc. can be used in this application to describe various types of information, the information is not limited to the terms. These terms are only used to distinguish between information of the same type. For example, without departing from the scope of this application, first information can also be referred to as second information, and similarly, the second information can be referred to as the first information. Depending on the context, for example, the word “if” used here can be explained as “while”, “when”, or “in response to determining”.

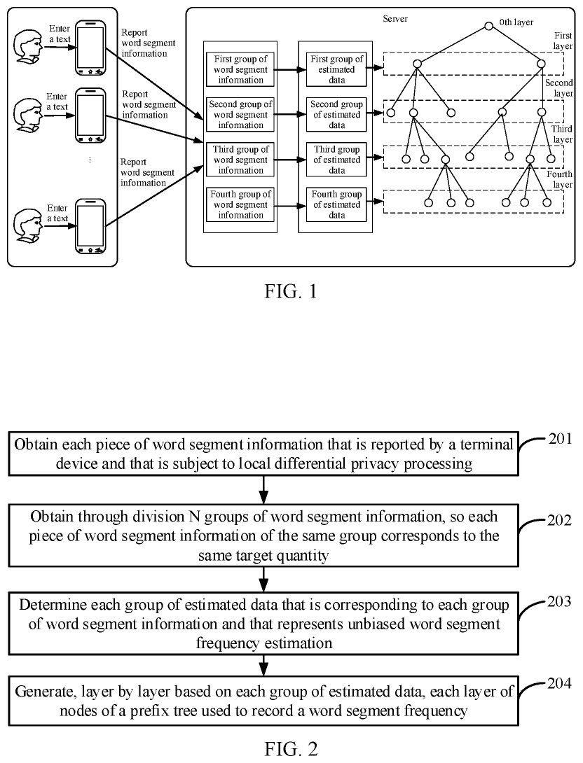

As shown in FIG. 1, in a scenario shown in FIG. 1, a user enters text information into a held terminal device, and the terminal device performs word segmentation processing on the text information entered by the user to obtain a plurality of word segments, where each word segment includes one or more word units (for example, each word segment in this scenario includes a maximum of four word units). The terminal device performs local differential privacy processing on each obtained word segment to obtain each target vector corresponding to each word segment, and generates each piece of word segment information corresponding to each word segment. Word segment information corresponding to any word segment can include a target vector corresponding to the word segment and a target quantity of word units forming the word segment. The terminal device reports each piece of obtained word segment information to a server.

The server receives word segment information reported by a plurality of terminal devices, and summarizes and groups the received word segment information, so target quantities corresponding to the same group of word segment information are equal. For example, word segment information corresponding to a word segment formed by one word unit is divided into one group as the first group of word segment information. Word segment information corresponding to a word segment formed by two word units is divided into one group as the second group of word segment information. By analogy, in this scenario, a total of four groups of word segment information including the third group of word segment information and the fourth group of word segment information can be obtained.

Then, each group of estimated data that is corresponding to each group of word segment information and that represents unbiased word segment frequency estimation is determined. For example, the first group of estimated data can be determined based on the first group of word segment information, and the first group of estimated data can represent unbiased frequency estimation of a word segment formed by one word unit. The second group of estimated data can be determined based on the second group of word segment information, and the second group of estimated data can represent unbiased frequency estimation of a word segment formed by two word units. By analogy, in this scenario, a total of four groups of estimated data including the third group of estimated data and the fourth group of estimated data can be obtained.

Finally, a prefix tree used to record a word segment frequency can be generated and output based on each group of estimated data as a result of word segment frequency estimation. Specifically, a root node of the prefix tree can be first generated as a 0th-layer node. Then, each node at an nth layer is obtained based on an nth group of estimated data, each node at the nth layer corresponds to one n-tuple word segment formed by n word units, and a frequency of the corresponding n-tuple word segment is recorded in each node at the nth layer. For example, each node at the first layer can be obtained based on the first group of estimated data, each node at the first layer corresponds to one 1-tuple word segment formed by one word unit, and a frequency of the corresponding 1-tuple word segment is recorded in each node at the first layer. Each node at the second layer can be obtained based on the second group of estimated data, each node at the second layer corresponds to one 2-tuple word segment formed by two word units, and a frequency of the corresponding 2-tuple word segment is recorded in each node at the second layer. By analogy, in this scenario, the prefix tree further includes the third layer of nodes and the fourth layer of nodes.

The following describes the solutions provided in this specification in detail with reference to specific embodiments.

As shown in FIG. 2, the method shown in FIG. 2 can be applied to a server, and the server can be implemented as any device, platform, server, or device cluster with a computing and processing capability. The method includes the following steps: Step 201: Obtain each piece of word segment information that is reported by a terminal device and that is subject to local differential privacy processing.

In this embodiment, the involved terminal device can be any terminal device on which text information can be entered or viewed. A person skilled in the art can understand that the terminal device can include but is not limited to a mobile terminal device such as a smartphone, an intelligent wearable device, a tablet computer, a personal digital assistant, a laptop computer, and a desktop computer.

In this embodiment, the server can obtain a plurality of pieces of word segment information respectively reported by a plurality of terminal devices. Any piece of word segment information corresponds to a word segment formed by one or more word units. The word segment information can include a target vector and a target quantity, where the target vector represents the corresponding word segment and that local differential privacy processing is performed, the target quantity represents a quantity of word units forming the word segment, and the target quantity is less than or equal to a predetermined value N.

Specifically, in this embodiment, for any terminal device, first, a predetermined word segmentation operation can be performed, based on a predetermined dictionary, on text information entered or viewed by a user, so as to split the text information into word units in the predetermined dictionary. Then, a plurality of word segments are combined according to the split word units, and each word segment includes one or more word units. In addition, a quantity of word units forming each word segment is less than or equal to the predetermined value N. The word unit can be a word or can be a phrase.

For example, the user enters text information “Yi tai fang zhong you Jiang zhong bu tong de shu ju lei xing”, the predetermined value N=3, and the text information can be split into the following word units: Yi tai fang, zhong, you, bu tong de, shu ju, and lei xing. Then, the following word segments are combined based on the split word units: Yi tai fang, zhong, you, bu tong de, shu ju, lei xing, yi tai fanglzhong, zhonglyou, youlbu tong de, bu tong delshu ju, shu xing, yi tai fanglzhonglyou, zhonglyoulbu tong de, youlbu tong delshu ju, bu tong delshu xing, where symbol “1” is a symbol separating word units.

Then, after obtaining the previous word segments, the terminal device performs local differential privacy processing on each word segment to obtain a target vector corresponding to each word segment. A target vector corresponding to any word segment can be obtained in the following method: first, one hash function is randomly selected from a plurality of predetermined hash functions, and is used as a target hash function. Hash calculation is performed on the word segment by using the target hash function, to obtain a target hash value of the word segment. Finally, the target vector is determined based on the target hash value in a method of satisfying differential privacy.

For example, in a specific implementation, a character string corresponding to the word segment is S. One hash function Hⱼ can be randomly selected from k predetermined hash functions H₁, H₂, . . . , and Hₖ as the target hash function. j is a serial number corresponding to Hⱼ. Hⱼ is used to perform hash calculation on the character string S of the word segment to obtain a target hash value h=Hⱼ(S). In addition, a random vector v is generated, and a value of the random vector v in each dimension is 1 or −1, where the probability that the value in each dimension is −1 is:

$$P = \frac{{e}^{\frac{ε}{2}}}{1 + {e}^{\frac{ε}{2}}}$$

ε is a predetermined privacy budget and is used to indicate a privacy protection level. A flip operation is performed on an hth bit of v to obtain a target vector. For example, if the hth bit of v is 1, 1 of the hth bit is flipped to −1, and if the hth bit of v is −1, −1 of the hth bit is flipped to 1.

It can be understood that the previous specific implementation is merely an example for description, and local differential privacy processing can be performed on the word segment in any other reasonable method to obtain the target vector. A specific method of obtaining the target vector is not limited in this embodiment.

Step 202: Obtain through division N groups of word segment information, so each piece of word segment information of the same group corresponds to the same target quantity.

In this embodiment, a plurality of pieces of word segment information from a plurality of terminal devices can be summarized, grouped, and divided into N groups of word segment information, so each piece of word segment information of the same group corresponds to the same target quantity. For example, if the predetermined value N=3, three groups of word segment information: G1, G2, and G3 can be obtained through division, where a target quantity corresponding to each piece of word segment information in group G1 is 1, a target quantity corresponding to each piece of word segment information in group G2 is 2, and a target quantity corresponding to each piece of word segment information in group G3 is 3.

Step 203: Determine each group of estimated data that is corresponding to each group of word segment information and that represents unbiased word segment frequency estimation.

In this embodiment, for any group of word segment information, estimated data corresponding to the group of word segment information and that represent unbiased word segment frequency estimation can be determined. Because N groups of word segment information are obtained through division, N groups of estimated data can be obtained, and estimated data of the same group also correspond to the same target quantity.

For example, referring to the specific implementation provided in step 201, any piece of word segment information can include a target vector and a target quantity, and the word segment information can further include a serial number j of a target hash function used to obtain the target vector. A reference vector corresponding to each piece of word segment information in the group of word segment information can be calculated by using the following equation:

$${\overline{x}}_{i} = \frac{k}{2} ( c \cdot {\overline{v}}_{i} + \overline{e} )$$

v̅ᵢ̅ represents a target vector corresponding to an ith piece of word segment information in the group of word segment information, x̅ᵢ̅ represents a reference vector corresponding to the ith piece of word segment information, ē is a unit vector that is the same as the target vector in dimension, k is a predetermined quantity of hash functions, c is a constant, and c can be expressed as:

$$c = \frac{{e}^{\frac{ε}{2}} + 1}{{e}^{\frac{ε}{2}} - 1}$$

ε is a predetermined privacy budget and is equal to the privacy budget c involved in the specific implementation provided in step 201.

Then, reference vectors corresponding to word segment information with the same serial number are added based on serial numbers of target hash functions corresponding to the group of word segment information to obtain k vectors. The k vectors are arranged in ascending order of serial numbers as row vectors or column vectors to obtain a target matrix. The target matrix is a group of estimated data that is corresponding to the group of word segment information and that represents unbiased word segment frequency estimation.

It can be understood that the previous example is an implementation of determining each group of estimated data provided merely for the specific implementation involved in step 201. Actually, for different differential privacy processing methods, each group of estimated data can be determined in different methods. A specific method of determining each group of estimated data is not limited in this embodiment.

Step 204: Generate, layer by layer based on each group of estimated data, each layer of nodes of a prefix tree used to record a word segment frequency.

In this embodiment, each layer of nodes of the prefix tree used to record the word segment frequency can be generated layer by layer based on each group of estimated data, so as to obtain the prefix tree. Specifically, first, a root node of the prefix tree is generated, the root node of the prefix tree is used as a 0th-layer node, and the 0th-layer node represents an empty character. Next, starting from the first layer, each layer of nodes of the prefix tree is generated layer by layer.

Specifically, the following step a to step d are used to generate an nth layer of nodes, where n is an integer greater than or equal to 1 and less than or equal to N: Step a: Obtain each (n−1)-tuple word segment represented by each node at an (n−1)th layer.

In this embodiment, each (n−1)-tuple word segment represented by each node at the (n−1)th layer is obtained. An (n−1)-tuple word segment represented by any node at the (n−1)th layer is formed by sequentially arranging word units corresponding to the root node to the node. If n=1, a 0-tuple word segment represented by the 0th-layer node is obtained, that is, an empty character.

Step b: Determine a plurality of candidate n-tuple word segments for the nth layer of nodes based on each (n−1)-tuple word segment.

In this embodiment, a plurality of candidate n-tuple word segments used for the nth layer of nodes can be determined based on each (n−1)-tuple word segment. Specifically, each (n−1)-tuple word segment can be used as a prefix, and is separately combined with each predetermined word unit in a predetermined dictionary, and a plurality of n-tuple word segments formed as such are determined as the plurality of candidate n-tuple word segments. For example, if (n−1)-tuple word segments represented by two nodes in the (n−1)th layer of nodes are respectively x and w (both x and w are (n−1)-tuple word segments formed by (n−1) word units), and the predetermined dictionary includes word units A, B, and C, n-tuple word segments formed by combining x, as a prefix, with A, B, and C are respectively xA, xB, and xC, and n-tuple word segments formed by combining w, as a prefix, with A, B, and C are respectively wA, wB, and wC. xA, xB, xC, wA, wB, and wC can be determined as candidate n-tuple word segments.

Step c: Calculate frequency salient distribution information of the candidate n-tuple word segment based on an nth group of estimated data corresponding to a target quantity n.

In this embodiment, the frequency salient distribution information of the candidate n-tuple word segment can be calculated based on the nth group of estimated data. The target quantity corresponding to the nth group of estimated data is n. Specifically, the frequency salient distribution information of the candidate n-tuple word segment can be calculated in the following method: First, each frequency of each candidate n-tuple word segment can be calculated based on the nth group of estimated data. Referring to the specific implementation provided in step 203, the target matrix is obtained as a group of estimated data representing unbiased word segment frequency estimation, and an nth matrix is the nth group of estimated data. For any candidate n-tuple word segment D, the previous k predetermined hash functions H₁, H₂, . . . , and Hₖ can be used to separately perform hash calculation on the candidate n-tuple word segment D to obtain target hash values H₁(D), H₂(D), . . . , and Hₖ(D). Then, each target element with the target hash value as a column is searched for in the nth matrix, an average value of the target elements is calculated, and a frequency of the candidate n-tuple word segment D is obtained based on the average value.

Then, each variance corresponding to each candidate n-tuple word segment can be calculated based on each frequency of each candidate n-tuple word segment, so as to obtain a standard deviation corresponding to each variance. Each z value corresponding to each candidate n-tuple word segment is calculated based on each variance corresponding to each candidate n-tuple word segment. For any candidate n-tuple word segment, a z value corresponding to the candidate n-tuple word segment is obtained by dividing a frequency of the candidate n-tuple word segment by a standard deviation corresponding to the candidate n-tuple word segment.

Finally, each p value (a p value corresponding to a sample is the probability that the sample or a sample more extreme than the sample is extracted) corresponding to each candidate n-tuple word segment can be calculated based on each z value corresponding to each candidate n-tuple word segment, and used as frequency salient distribution information corresponding to each candidate n-tuple word segment. For any candidate n-tuple word segment, a p value corresponding to the candidate n-tuple word segment is the probability that a random variable in standard normal distribution is greater than a z value corresponding to the candidate n-tuple word segment.

In another embodiment, another frequency-based indicator can alternatively be selected as salient distribution information, for example, the previous z value or another statistical distribution quantity determined based on the z value is used as salient distribution information.

Step d: Select, based on the frequency salient distribution information, several candidate n-tuple word segments as n-tuple word segments represented by the nth layer of nodes, and record, by using each node at the nth layer, a frequency of an n-tuple word segment represented by the node.

In this embodiment, based on the previous frequency salient distribution information, at least one candidate n-tuple word segment that satisfies a specific condition can be selected from a plurality of candidate n-tuple word segments, and used as the n-tuple word segment represented by the nth layer of nodes, and each node at the nth layer is used to record a frequency of an n-tuple word segment represented by the node. In an embodiment in which the p value is used as salient distribution information, each node at the nth layer can be used to record a variance and a p value of an n-tuple word segment represented by the node.

For example, the candidate n-tuple word segments include A, B, C, D, E, and F. Based on the previous frequency salient distribution information, A, B, and C that satisfy a specific condition can be selected from the candidate n-tuple word segments as the n-tuple word segments represented by the nth layer of nodes. Then, three nodes a, b, and c at the nth layer are generated, and the three nodes a, b, and c respectively represent A, B, and C. In addition, node a records a frequency, a variance, and a p value of A, node b records a frequency, a variance, and a p value of B, and node c records a frequency, a variance, and a p value of C.

According to the method for estimating a word segment frequency in differential privacy protection data provided in the previous embodiment of this specification, each piece of word segment information that is reported by a terminal device and that is subject to local differential privacy processing is obtained; N groups of word segment information are obtained through division, so each piece of word segment information of the same group corresponds to the same target quantity; each group of estimated data that is corresponding to each group of word segment information and that represents unbiased word segment frequency estimation is determined; and each layer of nodes of a prefix tree used to record a word segment frequency is generated layer by layer based on each group of estimated data. In the embodiments, in a process of generating an nth layer of nodes of the prefix tree, some candidate n-tuple word segments can be selected, based on frequency salient distribution information of candidate n-tuple word segments, as n-tuple word segments represented by the nth layer of nodes, and it is not necessary to traverse all n-tuple word segments formed by predetermined word units. This greatly reduces a calculation amount and improves calculation efficiency, and the n-tuple word segments represented by the nth layer of nodes and selected based on the frequency salient distribution information of word segments are more reasonable.

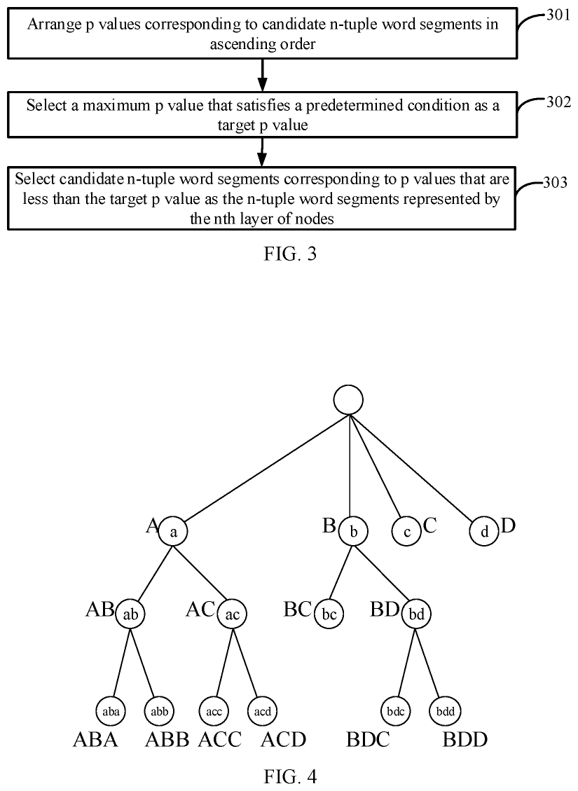

As shown in FIG. 3, an embodiment of FIG. 3 describes a process of selecting several candidate n-tuple word segments as n-tuple word segments represented by the nth layer of nodes. The method can be applied to a server and includes the following steps: Step 301: Arrange p values corresponding to candidate n-tuple word segments in ascending order.

Step 302: Select a maximum p value that satisfies a predetermined condition as a target p value.

In this embodiment, for any p value, if the p value is less than or equal to a target result corresponding to the p value, the p value satisfies the predetermined condition. The target result is a result obtained by dividing a product of a sequence number of the p value in the arrangement and a predetermined threshold set for the nth layer by a quantity of candidate n-tuple word segments.

For example, p values corresponding to the candidate n-tuple word segments are arranged in ascending order, and pᵢ is used to represent an ith p value in the arrangement. If pᵢ≤(i/N)*αₙ, pᵢ satisfies the predetermined condition. The maximum p value that satisfies the predetermined condition is used as the target p value. αₙ is a predetermined threshold set for the nth layer of nodes. Generally, a larger n indicates a larger αₙ.

Step 303: Select candidate n-tuple word segments corresponding top values that are less than the target p value as the n-tuple word segments represented by the nth layer of nodes.

According to the method for estimating a word segment frequency in differential privacy protection data provided in the previous embodiment of this specification, the maximum p value that satisfies the predetermined condition is selected as the target p value by arranging the p values corresponding to the candidate n-tuple word segments in ascending order, and candidate n-tuple word segments corresponding to p values that are less than the target p value are selected as the n-tuple word segments represented by the nth layer of nodes. Therefore, the n-tuple word segments represented by the nth layer of nodes selected based on the p values of the word segments are further reasonable.

In some optional implementations, the previous method can further include: using each node at the nth layer to record a variance and a p value of an n-tuple word segment represented by the node.

It is worthwhile to note that although the operations of the methods of the embodiments of this specification are described in a particular order in the previous embodiments, it is not required or implied that these operations must be performed in the particular order or that all the operations shown must be performed to achieve the desired results. In contrast, the execution order of the steps depicted in the flowchart can change. Additionally or alternatively, some steps can be omitted, a plurality of steps can be combined into one step for execution, and/or one step can be broken down into a plurality of steps for execution.

The following provides a schematic description of solutions in one or more embodiments of this specification with reference to a complete application instance.

An application scenario can be as follows: A predetermined dictionary includes word units A, B, C, and D. A server needs to estimate a frequency of a 1-tuple word segment, a 2-tuple word segment, and a 3-tuple word segment in differential privacy protection data based on the predetermined dictionary.

Specifically, first, the server obtains each piece of word segment information that is reported by a terminal device and that is subject to local differential privacy processing. The first group of word segment information, the second group of word segment information, and the third group of word segment information are obtained through division. A target quantity corresponding to the first group of word segment information is 1, a target quantity corresponding to the second group of word segment information is 2, and a target quantity corresponding to the third group of word segment information is 3.

Then, the first group of estimated data that is corresponding to the first group of word segment information and that represents unbiased word segment frequency estimation, the second group of estimated data that is corresponding to the second group of word segment information and that represents unbiased word segment frequency estimation, and the third group of estimated data that is corresponding to the third group of word segment information and that represents unbiased word segment frequency estimation are separately determined.

Then, each layer of nodes of a prefix tree used to record a word segment frequency can be generated layer by layer. As shown in FIG. 4, a root node of the prefix tree can be first generated as a 0th-layer node, and the 0th-layer node represents an empty character. Next, the word units A, B, C, and D in the predetermined dictionary are determined as four candidate 1-tuple word segments. Frequency salient distribution information corresponding to each candidate 1-tuple word segment is separately calculated, and based on the frequency salient distribution information corresponding to each candidate 1-tuple word segment, A, B, C, and D are selected as 1-tuple word segments represented by the first layer of nodes. Sub-node a of the root node is constructed, and node a represents 1-tuple word segment A, and a frequency of 1-tuple word segment A is recorded by using the node a. Sub-node b of the root node is constructed, node b represents 1-tuple word segment B, and a frequency of 1-tuple word segment B is recorded by using node b. Sub-node c of the root node is constructed, node c represents 1-tuple word segment C, and a frequency of 1-tuple word segment C is recorded by using node c. Sub-node d of the root node is constructed, node d represents 1-tuple word segment D, and a frequency of 1-tuple word segment D is recorded by using node d. Node a, node b, node c, and node d are nodes at the first layer of the prefix tree.

Then, 1-tuple word segments A, B, C, and D respectively represented by node a, node b, node c, and node d at the first layer are obtained, and 1-tuple word segments A, B, C, and D are used as prefixes to respectively form a plurality of 2-tuple word segments AA, AB, AC, AD, BA, BB, BC, BD, CA, CB, CC, CD, DA, DB, DC, and DD as a plurality of candidate 2-tuple word segments with the word units A, B, C, and D in the predetermined dictionary. Frequency salient distribution information corresponding to each candidate 2-tuple word segment is separately calculated, and based on the frequency salient distribution information corresponding to each candidate 2-tuple word segment, AB, AC, BC, and BD are selected as 2-tuple word segments represented by the second layer of nodes. Sub-nodes ab and ac of node a are constructed, and sub-nodes bc and bd of node b are constructed. Node ab represents 2-tuple word segment AB, and node ab is used to record a frequency of 2-tuple word segment AB. Node ac represents 2-tuple word segment AC, and node ac is used to record a frequency of 2-tuple word segment AC. Node bc represents 2-tuple word segment BC, and node bc is used to record a frequency of 2-tuple word segment BC. Node bd represents 2-tuple word segment BD, and node bd is used to record a frequency of 2-tuple word segment BD. Node ab, node ac, node bc, and node bd are nodes at the second layer of the prefix tree.

Finally, 2-tuple word segments AB, AC, BC, and BD respectively represented by node ab, node ac, node bc, and node bd at the second layer are obtained, and 2-tuple word segments AB, AC, BC, and BD are used as prefixes to respectively form a plurality of 3-tuple word segments ABA, ABB, ABC, ABD, ACA, ACB, ACC, ACD, BCA, BCB, BCC, BCD, BDA, BDB, BDC, and BDD as a plurality of candidate 3-tuple word segments with the word units A, B, C, and D in the predetermined dictionary. Frequency salient distribution information corresponding to each candidate 3-tuple word segment is separately calculated, and based on the frequency salient distribution information corresponding to each candidate 3-tuple word segment, ABA, ABB, ACC, ACD, BDC, and BDD are selected as 3-tuple word segments represented by the third layer of nodes. Sub-nodes aba and abb of node ab are constructed, sub-nodes acc and acd of node ac are constructed, and sub-nodes bdc and bdd of node bd are constructed. Node aba represents 3-tuple word segment ABA, and node aba is used to record a frequency of 3-tuple word segment ABA. Node abb represents 3-tuple word segment ABB, and node abb is used to record a frequency of 3-tuple word segment ABB. Node acc represents 3-tuple word segment ACC, and node acc is used to record a frequency of 3-tuple word segment ACC. Node acd represents 3-tuple word segment ACD, and node acd is used to record a frequency of 3-tuple word segment ACD. Node bdc represents 3-tuple word segment BDC, and node bdc is used to record a frequency of 3-tuple word segment BDC. Node bdd represents 3-tuple word segment BDD, and node bdd is used to record a frequency of 3-tuple word segment BDD. Node aba, node abb, node acc, node acd, node bdc, and node bdd are nodes at the third layer of the prefix tree.

It can be understood that, by using the previous solution, each layer of nodes of the prefix tree used to record the word segment frequency is generated layer by layer. In a process of generating an nth layer of nodes of the prefix tree, some candidate n-tuple word segments can be selected, based on frequency salient distribution information of candidate n-tuple word segments, as n-tuple word segments represented by the nth layer of nodes, and it is not necessary to traverse all n-tuple word segments formed by predetermined word units. This greatly reduces a calculation amount and improves calculation efficiency, and the n-tuple word segments represented by the nth layer of nodes and selected based on the frequency salient distribution information of word segments are more reasonable.

Corresponding to the previous embodiment of the method for estimating a word segment frequency in differential privacy protection data, this specification further provides an embodiment of an apparatus for estimating a word segment frequency in differential privacy protection data.

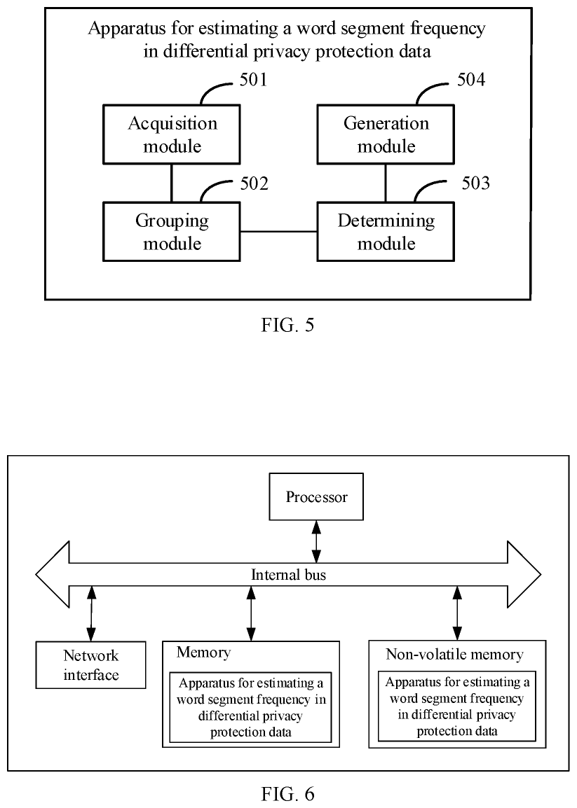

As shown in FIG. 5, the apparatus shown in FIG. 5 is applied to a server. The apparatus can include an acquisition module 501, a grouping module 502, a determining module 503, and a generation module 504.

The acquisition module 501 is configured to obtain each piece of word segment information that is reported by a terminal device and that is subject to local differential privacy processing. Any piece of word segment information corresponds to one word segment, and includes a target quantity that represents a quantity of word units included in the word segment, and the target quantity is less than or equal to a predetermined value N.

The grouping module 502 is configured to obtain through division N groups of word segment information, so each piece of word segment information of the same group corresponds to the same target quantity.

The determining module 503 is configured to determine each group of estimated data that is corresponding to each group of word segment information and that represents unbiased word segment frequency estimation.

The generation module 504 is configured to generate, layer by layer based on each group of estimated data, each layer of nodes of a prefix tree used to record a word segment frequency, where the generation module generates an nth layer of nodes in the following method: obtaining each (n−1)-tuple word segment represented by each node at an (n−1)th layer, where an (n−1)-tuple word segment represented by any node at the (n−1)th layer is formed by sequentially arranging word units corresponding to a root node to the node; determining a plurality of candidate n-tuple word segments for the nth layer of nodes based on each (n−1)-tuple word segment; calculating frequency salient distribution information of the candidate n-tuple word segment based on an nth group of estimated data corresponding to a target quantity n; and selecting, based on the frequency salient distribution information, several candidate n-tuple word segments as n-tuple word segments represented by the nth layer of nodes, and recording, by using each node at the nth layer, a frequency of an n-tuple word segment represented by the node, where 1≤n≤N.

In an implementation, the root node of the prefix tree is a 0th-layer node, and the 0th-layer node represents an empty character.

In another implementation, the generation module 504 determines the plurality of candidate n-tuple word segments for the nth layer of nodes based on each (n−1)-tuple word segment in the following method: determining, as the plurality of candidate n-tuple word segments, a plurality of n-tuple word segments formed by using each (n−1)-tuple word segment as a prefix and each predetermined word unit in a predetermined dictionary.

In another implementation, the generation module 504 calculates the frequency salient distribution information of the candidate n-tuple word segment based on the nth group of estimated data corresponding to the target quantity n in the following method: calculating each frequency of each candidate n-tuple word segment based on the nth group of estimated data; calculating each variance corresponding to each candidate n-tuple word segment based on each frequency; and calculating the frequency salient distribution information of the candidate n-tuple word segment based on each variance.

In another implementation, the generation module 504 calculates the frequency salient distribution information of the candidate n-tuple word segment based on each variance in the following method: calculating each z value corresponding to each candidate n-tuple word segment based on each variance; and calculating each p value corresponding to each candidate n-tuple word segment based on each z value, as the frequency salient distribution information of the candidate n-tuple word segment.

The generation module 404 selects, based on the frequency salient distribution information, several candidate n-tuple word segments as the n-tuple word segments represented by the nth layer of nodes in the following method: selecting, based on each p value, several candidate n-tuple word segments as the n-tuple word segments represented by the nth layer of nodes.

In another implementation, the generation module 504 selects, based on each p value, several candidate n-tuple word segments as the n-tuple word segments represented by the nth layer of nodes in the following method: arranging the p values in ascending order; selecting a maximum p value that satisfies a predetermined condition as a target p value, where any p value that satisfies the predetermined condition is less than or equal to a target result corresponding to the p value, and the target result is a result obtained by dividing a product of a sequence number of the p value in the arrangement and a predetermined threshold set for the nth layer by a quantity of candidate n-tuple word segments; and selecting candidate n-tuple word segments corresponding to p values that are less than the target p value as the n-tuple word segments represented by the nth layer of nodes.

In another implementation, the generation module 504 is further configured to use each node at the nth layer to record a variance and a p value of an n-tuple word segment represented by the node.

In another implementation, the any piece of word segment information can further include a target vector representing the word segment, and the target vector is subject to local differential privacy processing.

In another implementation, the target vector representing the word segment is obtained in the following method: selecting one hash function from a plurality of predetermined hash functions as a target hash function; calculating a target hash value of the word segment by using the target hash function; and determining the target vector based on the target hash value in a method of satisfying differential privacy.

It should be understood that the previous apparatus can be predetermined in the server, or can be loaded into the server in a download method etc. Corresponding modules in the previous apparatus can cooperate with modules in the server to implement the solution for estimating a word segment frequency in differential privacy protection data.

Because the apparatus embodiment corresponds to the method embodiment, for related parts, references can be made to related descriptions in the method embodiment. The apparatus embodiment described above is merely an example. The units described as separate parts can or cannot be physically separate, and parts displayed as units can or cannot be physical units, can be located in one position, or can be distributed on a plurality of network units. Some or all of the modules can be selected based on actual needs to achieve the objectives of the solutions of one or more embodiments of this specification. A person of ordinary skill in the art can understand and implement the embodiments of this application without creative efforts.

One or more embodiments of this specification further provide a computer readable storage medium. The storage medium stores a computer program. The computer program can be configured to perform the method for estimating a word segment frequency in differential privacy protection data provided in any one of the previous embodiments in FIG. 2 and FIG. 3.

Corresponding to the previous method for estimating a word segment frequency in differential privacy protection data, one or more embodiments of this specification further provide a schematic structural diagram of an electronic device according to an example embodiment of this specification shown in FIG. 6. Referring to FIG. 6, in terms of hardware, the electronic device includes a processor, an internal bus, a network interface, a memory, and a non-volatile memory, and certainly can further include hardware needed by other services. The processor reads a corresponding computer program from the non-volatile memory to the memory for running, and an apparatus for estimating a word segment frequency in differential privacy protection data is logically formed. Certainly, in addition to a software implementation, one or more embodiments of this specification do not exclude other implementations, for example, a logic device or a combination of hardware and software. That is, an execution body of the following processing procedure is not limited to each logical unit, and can also be hardware or a logic device.

The embodiments in this specification are described in a progressive way. For the same or similar parts of the embodiments, references can be made to the embodiments. Each embodiment focuses on a difference from other embodiments. Particularly, a system embodiment is similar to a method embodiment, and therefore is described briefly. For related parts, references can be made to related descriptions in the method embodiment.

Specific embodiments of this specification are described above. Other embodiments fall within the scope of the appended claims. In some situations, the actions or steps described in the claims can be performed in an order different from the order in the embodiments and the desired results can still be achieved. In addition, the process depicted in the accompanying drawings does not necessarily need a particular execution order to achieve the desired results. In some implementations, multi-tasking and concurrent processing is feasible or can be advantageous.

A person of ordinary skill in the art can be further aware that, in combination with the examples described in the implementations disclosed in this specification, units and algorithm steps can be implemented by electronic hardware, computer software, or a combination thereof. To clearly describe interchangeability between the hardware and the software, compositions and steps of each example are generally described above based on functions. Whether the functions are performed by hardware or software depends on particular applications and design constraint conditions of the technical solutions. A person of ordinary skill in the art can use different methods to implement the described functions for each particular application, but it should not be considered that the implementation goes beyond the scope of this application. The software module can reside in a random access memory (RAM), a memory, a read-only memory (ROM), an electrically programmable ROM, an electrically erasable programmable ROM, a register, a hard disk, a removable disk, a CD-ROM, or any other form of storage medium known in the art.

In the described specific implementations, the objective, technical solutions, and benefits of this application are further described in detail. It should be understood that the descriptions are merely specific implementations of this application, but are not intended to limit the protection scope of this application. Any modification, equivalent replacement, or improvement made without departing from the spirit and principle of this application should fall within the protection scope of this application.

1. A method for estimating a word segment frequency in differential privacy protection data, applied to a server, wherein the method comprises:
obtaining each piece of word segment information that is reported by a terminal device and that is subject to local differential privacy processing, wherein any piece of word segment information corresponds to one word segment, and comprises a target quantity that represents a quantity of word units comprised in the word segment, and the target quantity is less than or equal to a predetermined value N;
obtaining through division N groups of word segment information, so each piece of word segment information of the same group corresponds to the same target quantity;
determining each group of estimated data that is corresponding to each group of word segment information and that represents unbiased word segment frequency estimation; and
generating, layer by layer based on each group of estimated data, each layer of nodes of a prefix tree used to record a word segment frequency, wherein generating an nth layer of nodes comprises: obtaining each (n−1)-tuple word segment represented by each node at an (n−1)th layer, wherein an (n−1)-tuple word segment represented by any node at the (n−1)th layer is formed by sequentially arranging word units corresponding to a root node to the node; determining a plurality of candidate n-tuple word segments for the nth layer of nodes based on each (n−1)-tuple word segment; calculating frequency salient distribution information of the candidate n-tuple word segment based on an nth group of estimated data corresponding to a target quantity n; and selecting, based on the frequency salient distribution information, several candidate n-tuple word segments as n-tuple word segments represented by the nth layer of nodes, and recording, by using each node at the nth layer, a frequency of an n-tuple word segment represented by the node, wherein 1≤n≤N.

2. The method according to claim 1, wherein the root node of the prefix tree is a 0th-layer node, and the 0th-layer node represents an empty character.

3. The method according to claim 1, wherein the determining a plurality of candidate n-tuple word segments for the nth layer of nodes based on each (n−1)-tuple word segment comprises:
determining, as the plurality of candidate n-tuple word segments, a plurality of n-tuple word segments formed by using each (n−1)-tuple word segment as a prefix and each predetermined word unit in a predetermined dictionary.

4. The method according to claim 1, wherein the calculating frequency salient distribution information of the candidate n-tuple word segment based on an nth group of estimated data corresponding to a target quantity n comprises:
calculating each frequency of each candidate n-tuple word segment based on the nth group of estimated data;
calculating each variance corresponding to each candidate n-tuple word segment based on each frequency; and
calculating the frequency salient distribution information of the candidate n-tuple word segment based on each variance.

5. The method according to claim 4, wherein the calculating the frequency salient distribution information of the candidate n-tuple word segment based on each variance comprises:
calculating each z value corresponding to each candidate n-tuple word segment based on each variance; and
calculating each p value corresponding to each candidate n-tuple word segment based on each z value, as the frequency salient distribution information of the candidate n-tuple word segment;
wherein the selecting, based on the frequency salient distribution information, several candidate n-tuple word segments as n-tuple word segments represented by the nth layer of nodes comprises:
selecting, based on each p value, several candidate n-tuple word segments as the n-tuple word segments represented by the nth layer of nodes.

6. The method according to claim 5, wherein the selecting, based on each p value, several candidate n-tuple word segments as the n-tuple word segments represented by the nth layer of nodes comprises:
arranging the p values in ascending order;
selecting a maximum p value that satisfies a predetermined condition as a target p value, wherein any p value that satisfies the predetermined condition is less than or equal to a target result corresponding to the p value, and the target result is a result obtained by dividing a product of a sequence number of the p value in the arrangement and a predetermined threshold set for the nth layer by a quantity of candidate n-tuple word segments; and
selecting candidate n-tuple word segments corresponding to p values that are less than the target p value as the n-tuple word segments represented by the nth layer of nodes.

7. The method according to claim 4, wherein the method further comprises:
using each node at the nth layer to record a variance and a p value of an n-tuple word segment represented by the node.

8. The method according to claim 1, wherein the any piece of word segment information further comprises a target vector representing the word segment, and the target vector is subject to local differential privacy processing.

9. The method according to claim 8, wherein the target vector representing the word segment is obtained in the following method:
selecting one hash function from a plurality of predetermined hash functions as a target hash function;
calculating a target hash value of the word segment by using the target hash function; and
determining the target vector based on the target hash value in a method of satisfying differential privacy.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A computing device comprising a memory and a processor, wherein the memory stores executable instructions that, in response to execution by the processor, cause the computing device to:
obtain each piece of word segment information that is reported by a terminal device and that is subject to local differential privacy processing, wherein any piece of word segment information corresponds to one word segment, and comprises a target quantity that represents a quantity of word units comprised in the word segment, and the target quantity is less than or equal to a predetermined value N;
obtain through division N groups of word segment information, so each piece of word segment information of the same group corresponds to the same target quantity;
determine each group of estimated data that is corresponding to each group of word segment information and that represents unbiased word segment frequency estimation; and
generate, layer by layer based on each group of estimated data, each layer of nodes of a prefix tree used to record a word segment frequency, wherein generating an nth layer of nodes comprises: obtaining each (n−1)-tuple word segment represented by each node at an (n−1)th layer, wherein an (n−1)-tuple word segment represented by any node at the (n−1)th layer is formed by sequentially arranging word units corresponding to a root node to the node; determining a plurality of candidate n-tuple word segments for the nth layer of nodes based on each (n−1)-tuple word segment; calculating frequency salient distribution information of the candidate n-tuple word segment based on an nth group of estimated data corresponding to a target quantity n; and selecting, based on the frequency salient distribution information, several candidate n-tuple word segments as n-tuple word segments represented by the nth layer of nodes, and recording, by using each node at the nth layer, a frequency of an n-tuple word segment represented by the node, wherein 1≤n≤N.

22. A non-transitory computer-readable storage medium having stored therein instructions that, when executed by a processor of a device, cause the device to:
obtain each piece of word segment information that is reported by a terminal device and that is subject to local differential privacy processing, wherein any piece of word segment information corresponds to one word segment, and comprises a target quantity that represents a quantity of word units comprised in the word segment, and the target quantity is less than or equal to a predetermined value N;
obtain through division N groups of word segment information, so each piece of word segment information of the same group corresponds to the same target quantity;
determine each group of estimated data that is corresponding to each group of word segment information and that represents unbiased word segment frequency estimation; and
generate, layer by layer based on each group of estimated data, each layer of nodes of a prefix tree used to record a word segment frequency, wherein generating an nth layer of nodes comprises: obtaining each (n−1)-tuple word segment represented by each node at an (n−1)th layer, wherein an (n−1)-tuple word segment represented by any node at the (n−1)th layer is formed by sequentially arranging word units corresponding to a root node to the node; determining a plurality of candidate n-tuple word segments for the nth layer of nodes based on each (n−1)-tuple word segment; calculating frequency salient distribution information of the candidate n-tuple word segment based on an nth group of estimated data corresponding to a target quantity n; and selecting, based on the frequency salient distribution information, several candidate n-tuple word segments as n-tuple word segments represented by the nth layer of nodes, and recording, by using each node at the nth layer, a frequency of an n-tuple word segment represented by the node, wherein 1≤n≤N.
